(19) United States
(12) Patent Application Publication
(10) Pub. No.: US 2018/0118207 A1
(43) Pub. Date: May 3, 2018

(54) CRUISE CONTROL DEVICE AND CRUISE CONTROL METHOD

(71) Applicant: ISUZU MOTORS LIMITED, Tokyo (JP)

(72) Inventors: Shinichi ISHIGURO, Kawasaki-shi, Kanagawa (JP); Nobuyuki NISHIMURA, Yokohama-shi, Kanagawa (JP); Masao NISHIKIMI, Machida-shi, Tokyo (JP)

(73) Assignee: Isuzu Motors Limited, Tokyo (JP)

(21) Appl. No.: 15/561,257

(22) PCT Filed: Mar. 3, 2016
(86) PCT No.: PCT/JP2016/058629

§ 371 Date: Sep. 25, 2017

(30) Foreign Application Priority Data
Mar. 26, 2015 (JP) 2015-064244

(51) Int. Cl. B60W 30/14; G06K 9/00; B60W 40/076; B60W 40/105

(52) U.S. Cl. CPC B60W 30/143; B60W 40/105; B60W 40/076; G06K 9/00791

(57) ABSTRACT

A road information acquisition unit (12a) acquires information about the road in a prescribed segment forwards of a vehicle (1) that is traveling with the acceleration pedal actuated a first actuation amount, a vehicle information acquisition unit (12b) acquires information about the vehicle (1), a velocity prediction unit (12c) predicts, on the basis of the road information and the vehicle information, the changes in the vehicle velocity that would be brought about in the prescribed segment if the acceleration pedal actuation amount were a second actuation amount greater than the first actuation amount, and an acceleration control unit (12d) controls the acceleration pedal actuation amount such that the acceleration pedal actuation amount of the vehicle (1) becomes the second actuation amount if the predicted vehicle velocity minimal value is less than a target velocity.

### TECHNICAL FIELD

The present invention relates to a travel control device and a travel control method for controlling a travel of a vehicle such that the vehicle speed is set to a target speed.

### BACKGROUND ART

Conventionally, auto-cruising techniques to maintain the speed (vehicle speed) of a vehicle such as an automobile at a target speed have been developed. For example, PTL 1 discloses an auto-cruising control device that prevents the vehicle speed from being varied at the time when the vehicle travels from a level ground into a slope so as not to make the passenger uncomfortable.

To be more specific, this auto-cruising control device images the forward area in the travelling direction of the vehicle with an imaging device, and detects the road grade from the obtained image. Then, the auto-cruising control device calculates a fuel injection amount which does not cause the variation of the vehicle speed from the road grade and the target speed, and drives the engine at that fuel injection amount from a position before the slope.

### CITATION LIST

### Patent Literature

### PTL 1

### Japanese Patent Application Laid-Open No. 2010-234987

### SUMMARY OF INVENTION

### Technical Problem

However, the above-described conventional technique disclosed in PTL 1 detects the road grade based on the image imaged with the imaging device, and therefore, in the case of a road including an upslope, a downslope and another upslope in this order, the road grade cannot be easily detected. As a result, there is a risk that the fuel injection amount is not appropriately calculated and the fuel economy is degraded.

To solve the above-mentioned problems, an object of the present invention is to provide a travel control device and a travel control method which can control the vehicle to go up an upslope road without degrading the fuel economy, and can shorten the period until the vehicle reaches the crest while avoiding an unnecessary downshift even in the case where the vehicle travels on an upslope road in which the road grade changes in a certain section.

### Solution to Problem

To solve the above-mentioned problems, a travel control device of an embodiment of the present invention controls a travel of a vehicle such that a vehicle speed is set to a target speed, the travel control device including: an road information acquiring section that acquires information of a road in a predetermined section ahead of the vehicle that travels with an accelerator opening of a first opening; a vehicle information acquiring section that acquires information of the vehicle; a speed estimating section that estimates based on the information of the road and the information of the vehicle a transition of a vehicle speed in the predetermined section of a case where the vehicle travels with the accelerator opening of a second opening that is greater than the first opening; and an accelerator control section that sets the accelerator opening of the vehicle to the second opening when a minimum value of a vehicle speed estimated by the speed estimating section is smaller than the target speed.

A travel control method of an embodiment of the present invention is a method for controlling a travel of a vehicle such that a vehicle speed is set to a target speed, the method including: acquiring information of a road in a predetermined section ahead of the vehicle that travels with an accelerator opening of a first opening; acquiring information of the vehicle; estimating based on the information of the road and the information of the vehicle a transition of a vehicle speed in the predetermined section of a case where the vehicle travels with the accelerator opening of a second opening that is greater than the first opening; and setting the accelerator opening of the vehicle to the second opening when a minimum value of a vehicle speed estimated by the estimating is smaller than the target speed.

### Advantageous Effects of Invention

According to the present invention, even in the case where the vehicle travels on an upslope road in which the road grade changes in a certain section, the vehicle can go up the upslope road without degrading the fuel economy, and the period until the vehicle reaches the crest can be shortened while avoiding an unnecessary downshift.

### BRIEF DESCRIPTION OF DRAWINGS

FIG. 1 is a block diagram illustrating an example configuration of an automatic travel device according to an embodiment of the present invention;

FIG. 2 is a block diagram illustrating an example configuration of an automatic travel control device illustrated in FIG. 1;

FIG. 3 illustrates an example of a process of determining the necessity to change the accelerator opening according to the embodiment of the present invention; and

FIG. 4 is a flowchart of an example process of a travel control according to the embodiment of the present invention.

### DESCRIPTION OF EMBODIMENTS

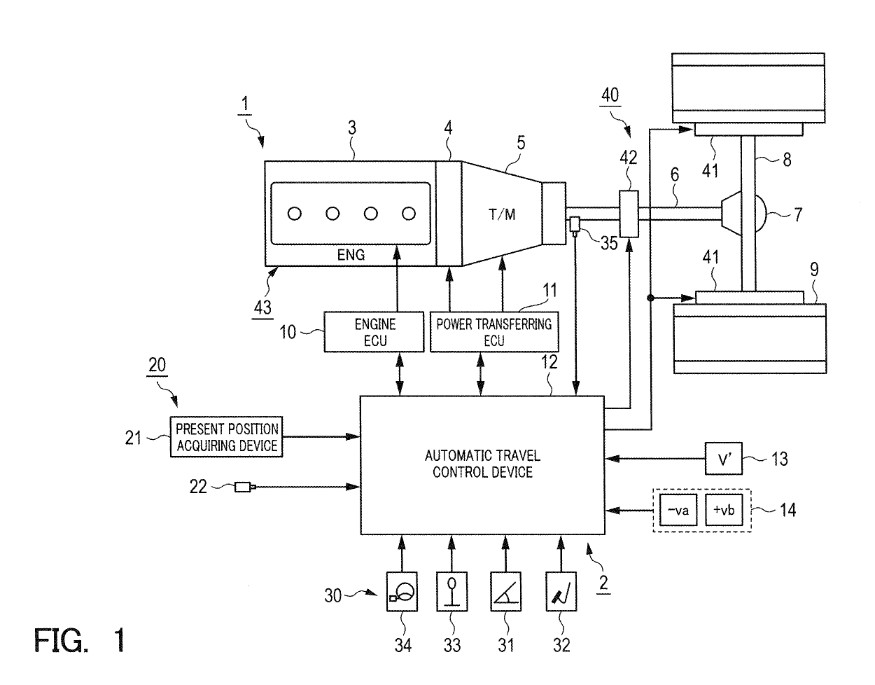

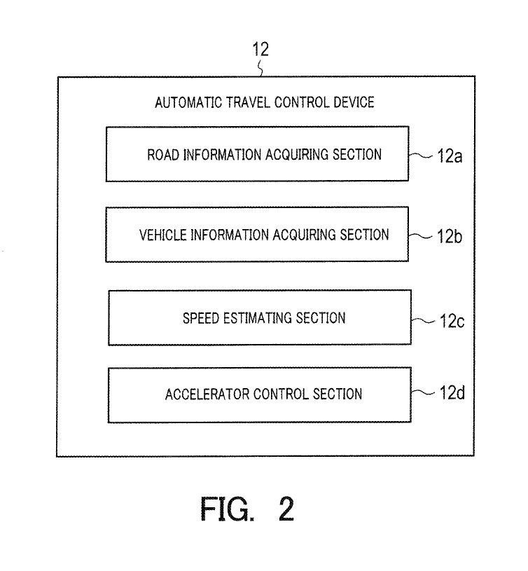

An embodiment of the present invention is described equal to or lower than with reference to the accompanying drawings. FIG. 1 is a block diagram illustrating an example configuration of automatic travel device 2 according to the embodiment of the present invention. In addition, FIG. 2 is a block diagram illustrating an example configuration of automatic travel control device 12 illustrated in FIG. 1.

It is to be noted that, while engine 3 is an in-line six-cylinder diesel engine in FIG. 1, the present invention is applicable also to a gasoline engine, and the arrangement and the number of the cylinders are not limited. In addition, while vehicle 1 is a large vehicle such as a truck in which a diesel engine is mounted in the following description, the present invention is not limited to large vehicles such as trucks.

As illustrated in FIG. 1, in vehicle 1 in which automatic travel device 2 of the present embodiment is mounted, the power of engine 3 is transmitted to transmission 5 via clutch 4, and transmitted from transmission 5 to differential gear 7 through a propeller shaft 6, and further, transmitted from differential gear 7 to wheel 9 through drive shaft 8. In this manner, the power of engine 3 is transmitted to wheel 9, and thus vehicle 1 travels.

Automatic travel device 2 of the present embodiment controls the output of engine 3, the connection and disconnection of clutch 4, and the transmission of transmission 5 for the automatic travel of vehicle 1. Automatic travel device 2 includes a plurality of control devices.

To be more specific, automatic travel device 2 includes control engine ECU (engine control unit) 10 that controls the output of engine 3, power transferring ECU (power transferring control unit) 11 that controls the connection and disconnection of clutch 4 and the transmission of transmission 5, and automatic travel control device 12 that controls the automatic travel of vehicle 1.

Each of engine ECU 10, power transferring ECU 11, and automatic travel control device 12 is composed of a micro controller. Engine ECU 10, power transferring ECU 11, and automatic travel control device 12 are connected with one another with an in-vehicle network, and required data and control signals are exchanged therebetween.

In addition, automatic travel device 2 includes, at a dashboard of a driver's seat not illustrated, target-vehicle speed setting device 13 and increment/reduction value setting device 14, and target-vehicle speed setting device 13 and increment/reduction value setting device 14 are connected with automatic travel control device 12.

Target-vehicle speed setting device 13 is a device that is manually operated by the driver before the automatic travel of vehicle 1 is started, to set target-vehicle speed V′ [km/h] of vehicle 1 in the automatic travel. When target-vehicle speed V′ is set in target-vehicle speed setting device 13 by the driver, the target-vehicle speed V′ is transmitted to automatic travel control device 12, and stored in a storage device of automatic travel control device 12.

Increment/reduction value setting device 14 is a device that is operated by the driver before the automatic travel of vehicle 1 is started and after target-vehicle speed V′ is set, to set both speed reduction value −va [km/h] and speed increment value +vb [km/h] of vehicle 1 in the automatic travel.

When both speed reduction value −va and speed increment value +vb are set in increment/reduction value setting device 14 by the driver, speed reduction value −va and speed increment value +vb are transmitted to automatic travel control device 12, and stored in a storage device of automatic travel control device 12.

In addition, automatic travel control device 12 adds speed reduction value −va and speed increment value +vb to target-vehicle speed V′ to calculate lower limit target-vehicle speed Va′ [km/h] and upper limit target-vehicle speed Vb′ [km/h], and stores the calculated values in the storage device of automatic travel control device 12.

For example, in the case where target-vehicle speed V′ is 80 km/h, speed reduction value −va is −5 km/h, and speed increment value +vb is +10 km/h, lower limit target-vehicle speed Va′ is 75 km/h and upper limit target-vehicle speed Vb′ is 90 km/h. It is to be noted that speed reduction value −va and speed increment value +vb may be set to zero.

Lower limit target-vehicle speed Va′ and upper limit target-vehicle speed Vb′ define a range of vehicle speed V [km/h] which can be accepted by the driver in the automatic travel of vehicle 1.

In addition, road information acquiring device 20 is a device for acquiring road information about the road ahead. The road ahead is the road extending from the present position of the vehicle in the travelling direction of the vehicle.

For example, road information acquiring device 20 includes present position acquiring device 21 that is a receiver of a global positioning system (GPS), and periphery sensor 22 that detects the distance from vehicles around the travelling vehicle such as a vehicle travelling ahead and/or a vehicle travelling on a side, and the difference in vehicle speed from other vehicles around the travelling vehicle.

Vehicle information acquiring device 30 is a device for acquiring vehicle information of vehicle 1. For example, vehicle information acquiring device 30 includes accelerator sensor 31 that detects the pressing amount of the accelerator pedal, brake switch 32 that detects the presence/absence of the pressing of the brake pedal, shift lever 33, turn-signal switch 34, and vehicle speed sensor 35 that detects vehicle speed V of vehicle 1. In addition, engine ECU 10 and power transferring ECU 11 are also included in vehicle information acquiring device 30.

Braking device 40 is a device for applying a braking force to vehicle 1. Braking device 40 includes foot brake 41, retarder 42, and auxiliary brake 43 such as an exhaust brake that is controlled with engine ECU 10 and/or power transferring ECU 11.

As illustrated in FIG. 2, automatic travel control device 12 includes road information acquiring section 12a, vehicle information acquiring section 12b, speed estimating section 12c, and accelerator control section 12d.

Road information acquiring section 12a acquires road information in a predetermined section ahead of the present point of vehicle 1.

To be more specific, road information acquiring section 12a determines the road ahead based on the present position acquired by present position acquiring device 21, map data stored in advance and the like, and acquires information about the road grade in a predetermined section of the acquired road ahead, the curve in the predetermined section of the road ahead, the presence/absence of traffic lights and the like. In addition, road information acquiring section 12a acquires information about the distance and the difference in vehicle speed from other travelling vehicles around the vehicle and the like, which is detected by periphery sensor 22.

It is to be noted that road information acquiring section 12a may determine the predetermined section in accordance with the speed of vehicle 1. For example, road information acquiring section 12a may calculate a distance based on the product of the present vehicle speed and a predetermined time, and may set, as the predetermined section, a section corresponding to the distance from the present point of vehicle 1 in the road ahead.

Vehicle information acquiring section 12b acquires vehicle information required for the automatic travel of vehicle 1.

To be more specific, vehicle information acquiring section 12b acquires information about the pressing amount of the accelerator pedal detected by accelerator sensor 31, the presence/absence of the pressing of the brake pedal detected by brake switch 32, the operation of shift lever 33 and/or turn-signal switch 34, vehicle speed V of vehicle 1 detected by vehicle speed sensor 35, the output of engine 3 used in engine ECU 10 and power transferring ECU 11, the weight of vehicle 1, the transmission gear of transmission 5 and the like.

It is to be noted that the information acquired by road information acquiring section 12a and vehicle information acquiring section 12b is not limited to the above-mentioned information, and other information required for the automatic travel of vehicle 1 may be acquired. In addition, the devices provided in road information acquiring device 20 and/or vehicle information acquiring device 30 may be changed or additionally provided in accordance with the information to be acquired.

On the basis of the road information and the vehicle information, speed estimating section 12c estimates a transition of the speed of vehicle 1 in a predetermined section of the case where vehicle 1 travels with the maximum accelerator opening. The method of estimating the vehicle speed with speed estimating section 12c is described in detail later.

Accelerator control section 12d controls the accelerator to maximize the accelerator opening of the vehicle 1 when the maximum value of the vehicle speed in the predetermined section estimated by speed estimating section 12c is smaller than upper limit target vehicle speed Vb′ and the minimum value of the speed estimated by speed estimating section 12c is smaller than target vehicle speed V′. Upper limit target vehicle speed Vb′ and target vehicle speed V′, which are vehicle speeds set by the driver, are obtained as vehicle information.

In this manner, by maximizing the accelerator opening at the time point when the speed is determined to be smaller than target vehicle speed V′, the vehicle speed can be increased at an early stage, and an unnecessary downshift at an upslope road can be suppressed. As a result, fuel economy can be improved, and moreover the period until the vehicle reaches the crest can be shortened.

In addition, by maximizing the accelerator opening when the maximum value of the estimated vehicle speed is smaller than upper limit target vehicle speed Vb′, it is possible to control vehicle 1 to go up an upslope road at a vehicle speed equal to or lower than the upper limit speed.

Further, by maximizing the accelerator opening, an unnecessary downshift at an upslope road can be further suppressed. As a result, fuel economy can be further improved, and the period until the vehicle reaches the crest can be further shortened.

Next, the method of estimating the vehicle speed with speed estimating section 12c is described. When the present vehicle speed is represented by Vₙ [km/h], and the estimated vehicle speed at a position ahead by L [m] is represented by Vₙ₊₁ [km/h], the relationship between Vₙ and Vₙ₊₁ is expressed by the Expression (1).

[Expression 1]

Vₙ₊₁=Vₙ+ΔVₙ (1)

Here, ΔVₙ [km/h] is calculated with the Expression (2).

[Expression 2]

ΔVₙ=3.6²×(G−θ/100)×9.81×L/Vₙ (2)

Here, θ [%] is an average road grade from the present position to a position ahead of the present position by L. The average road grade is calculated from the above-described map data.

In addition, G [km/h²] is the acceleration of the case where the vehicle travels with the present transmission gear and the maximum accelerator opening, and is calculated with the Expression (3).

[Expression 3]

G=[tq·rt·rf·η/tr−{(M·rrc)+(arc·Vₙ²)}]/M (3)

Here, tq [kgf·m] is the maximum torque of engine 3 of the case where the vehicle travels with the present transmission gear at vehicle speed Vₙ, rt the gear ratio of the present transmission gear, rf the gear ratio of the final gear, η the transmission efficiency, tr [m] the tire radius, M [kg] the vehicle weight, rrc the roll resistance coefficient, and arc [kgf/(km/h)²] the air resistance coefficient. These pieces of information are included in the vehicle information that is acquired by vehicle information acquiring section 12b.

By use of Expressions (1) to (3), speed estimating section 12c can estimate vehicle speed Vm of a position ahead of the present position by mL (m=1, 2, . . . ) with the present vehicle speed Vm as the initial value.

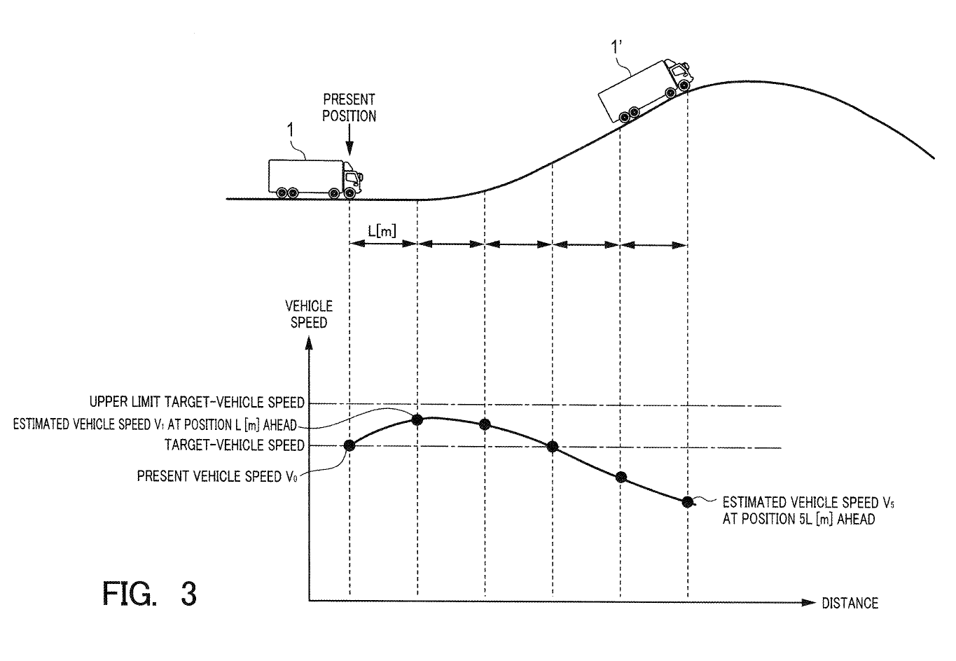

Next, an example process of determining the necessity to change the accelerator opening according to the embodiment of the present invention is described. FIG. 3 illustrates an example of the process of determining the necessity to change the accelerator opening according to the embodiment of the present invention.

FIG. 3 illustrates vehicle 1 travelling on a flat road, and vehicle 1′ travelling on an upslope road ahead thereof by 5L. In addition, the graph of FIG. 3 shows a transition of an estimated vehicle speed.

In the case of FIG. 3, the maximum value of estimated speed V₁ is smaller than upper limit target vehicle speed Vb′ and minimum value of estimated speed V₅ is smaller than target vehicle speed V′. In this case, accelerator control section 12d determines that the accelerator opening should be maximized, and operates to maximize the accelerator opening at the present position of the vehicle, that is, at a position on the flat road.

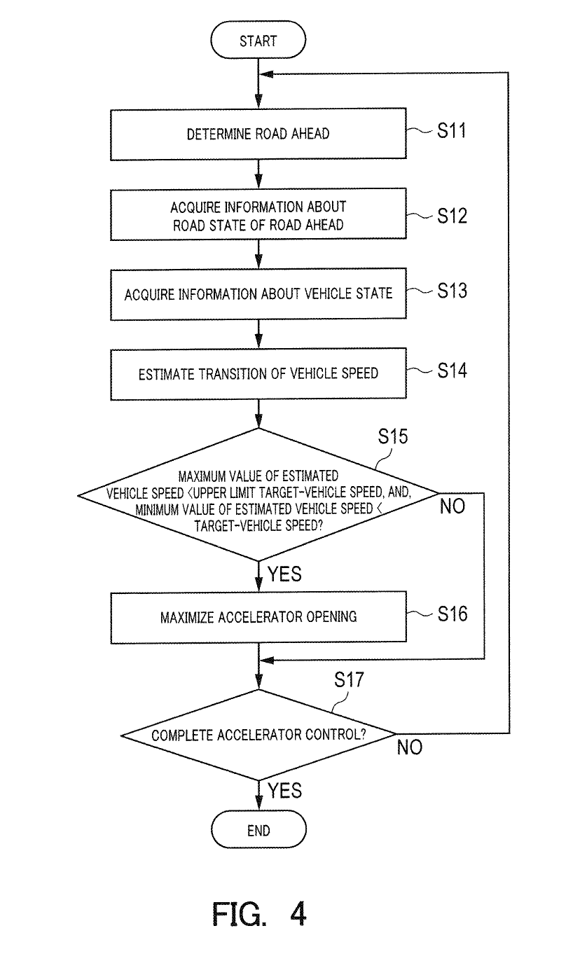

Next, an example process of the travel control according to the embodiment of the present invention is described. FIG. 4 is a flowchart of an example process of the travel control according to the embodiment of the present invention.

First, road information acquiring section 12a determines the road ahead (step S11), and acquires road information about the road ahead (step S12). Then, vehicle information acquiring section 12b acquires information about the vehicle state (step S13).

Subsequently, on the basis of the road information and the vehicle information, speed estimating section 12c estimates the transition of the vehicle speed of vehicle 1 in a predetermined section of the case where vehicle 1 travels with the maximum accelerator opening (step S14).

Next, accelerator control section 12d determines whether the maximum value of the vehicle speed estimated by speed estimating section 12c is smaller than upper limit target vehicle speed Vb′ and the minimum value of the speed estimated by speed estimating section 12c is smaller than target vehicle speed V′ (step S15).

Then, when the maximum value of the estimated vehicle speed is smaller than upper limit target vehicle speed Vb′ and the minimum value of the estimated vehicle speed is smaller than target vehicle speed V′ (YES at step S15), accelerator control section 12d controls the accelerator opening to maximize the accelerator opening at the present position of the vehicle, that is, at a position on the flat road (step S16).

After step S16, or when a condition where the maximum value of the estimated vehicle speed is smaller than upper limit target vehicle speed Vb′ and the minimum value of the estimated vehicle speed is smaller than target vehicle speed V′ is not satisfied at step S15 (NO at step S15), accelerator control section 12d determines whether to complete the accelerator control (step S17).

For example, accelerator control section 12d determines that this transmission control is to be completed when the driver has requested completion of the automatic travel. Accelerator control section 12d determines that the accelerator control is not to be completed when the transmission gear is switched during the travel.

When accelerator control section 12d determines that the accelerator control is to be completed (YES at step S17), control section 12d completes the accelerator control. When accelerator control section 12d determines that the accelerator control is not to be completed (NO at step S17), the processes subsequent to step S11 are again performed.

While speed estimating section 12c estimates the transition of the vehicle speed of the case where vehicle 1 travels in a predetermined section of the road ahead with the present transmission gear and the maximum accelerator opening in the embodiment of the present invention described above, the present invention is not limited to this.

For example, speed estimating section 12c may estimate the transition of the vehicle speed of the case where the vehicle travels with an accelerator opening equal to or greater than the present accelerator opening, not the maximum accelerator opening.

Also in this case, when the maximum value of the vehicle speed estimated by speed estimating section 12c is smaller than upper limit target vehicle speed Vb′ and the minimum value of the speed estimated by speed estimating section 12c is smaller than target vehicle speed V′, accelerator control section 12d operates to maximize the accelerator opening at the present position of the vehicle, that is, at a position on the flat road.

In addition, the condition where the maximum value of the vehicle speed is smaller than upper limit target vehicle speed Vb′ may not be taken into consideration.

As described above, according to the present embodiment, in travel control device 12 that controls a travel of a vehicle such that a vehicle speed is set to a target speed, road information acquiring section 12a acquires information of a road in a predetermined section ahead of the vehicle that travels with an accelerator opening of a first opening; vehicle information acquiring section 12b acquires information of the vehicle; speed estimating section 12c estimates based on the information of the road and the information of the vehicle a transition of a vehicle speed in the predetermined section of a case where the vehicle travels with the accelerator opening of a second opening that is greater than the first opening; and accelerator control section 12d sets the accelerator opening of the vehicle to the second opening when a minimum value of the vehicle speed estimated by speed estimating section 12c is smaller than the target speed. With this configuration, even in the case where the vehicle travels on an upslope road in which the road grade changes in a certain section, the vehicle can go up the upslope road without degrading the fuel economy, and the period until the vehicle reaches the crest can be shortened while avoiding an unnecessary downshift.

In addition, according to the present embodiment, accelerator control section 12d controls the accelerator opening such that of the accelerator opening of vehicle 1 is set to the second opening when the maximum value of the vehicle speed estimated by speed estimating section 12c is smaller than a predetermined upper limit and the minimum value of the vehicle speed estimated by speed estimating section 12c is smaller than a target speed. With this configuration, it is possible to control vehicle 1 to go up an upslope road at a vehicle speed equal to or lower than the upper limit speed.

In addition, in the present embodiment, the second opening is a maximized opening. With this configuration, an unnecessary downshift at an upslope road can be further suppressed, fuel economy can be further improved, and the period until the vehicle reaches the crest can be further shortened.

In addition, in the present embodiment, road information acquiring section 12a determines the predetermined section in accordance with the present speed of the vehicle. With this configuration, the predetermined section for the vehicle speed estimation can be further appropriately changed.

This application is entitled to and claims the benefit of Japanese Patent Application No. 2015-064244 dated Mar. 26, 2015, the disclosure of which including the specification, drawings and abstract is incorporated herein by reference in its entirety.

### INDUSTRIAL APPLICABILITY

The present invention is applicable to a travel control device and a travel control method for controlling a travel of the vehicle such that the vehicle speed is set to a target speed.

### REFERENCE SIGNS LIST

1 Vehicle
2 Automatic travel device
3 Engine
4 Clutch
5 Transmission
10 Engine ECU (engine control unit)
11 Power transferring ECU (power transferring control unit)
12 Automatic travel control device
12a Road information acquiring section
12b Vehicle information acquiring section
12c Speed estimating section
12d Accelerator control section
13 Target-vehicle speed setting device
14 Increment/reduction value setting device
20 Road information acquiring device
30 Vehicle information acquiring device
40 Braking device

1. A travel control device that controls a travel of a vehicle such that a vehicle speed is set to a target speed, the travel control device comprising:
a road information acquiring section that acquires information of a road in a predetermined section ahead of the vehicle that travels with an accelerator opening of a first opening;
a vehicle information acquiring section that acquires information of the vehicle;
a speed estimating section that estimates, based on the information of the road and the information of the vehicle, a transition of a vehicle speed in the predetermined section of a case where the vehicle travels with the accelerator opening of a second opening that is greater than the first opening; and
an accelerator control section that sets the accelerator opening of the vehicle to the second opening when a minimum value of the transition of the vehicle speed estimated by the speed estimating section is smaller than the target speed.

2. The travel control device according to claim 1, wherein the accelerator control section sets the accelerator opening of the vehicle to the second opening when a maximum value of the transition of the vehicle speed estimated by the speed estimating section is smaller than a predetermined upper limit and the minimum value of the transition of the vehicle speed estimated by the speed estimating section is smaller than the target speed.

3. The travel control device according to claim 1, wherein the second opening is a maximized opening.

4. The travel control device according to claim 1, wherein the road information acquiring section determines the predetermined section in accordance with a present speed of the vehicle.

5. The travel control device according to claim 1, wherein when a downshift is performed in the vehicle, the vehicle information acquiring section again acquires the information of the vehicle, and the speed estimating section again estimates the transition of the vehicle speed.

6. A travel control method for controlling a travel of a vehicle such that a vehicle speed is set to a target speed, the method comprising:
acquiring information of a road in a predetermined section ahead of the vehicle that travels with an accelerator opening of a first opening;
acquiring information of the vehicle;
estimating, based on the information of the road and the information of the vehicle, a transition of a vehicle speed in the predetermined section of a case where the vehicle travels with the accelerator opening of a second opening that is greater than the first opening; and
setting the accelerator opening of the vehicle to the second opening when a minimum value of the transition of the vehicle speed estimated by the estimating is smaller than the target speed.
